(19) United States
(12) Patent Application Publication
(10) Pub. No.: US 2011/0109618 A1
(43) Pub. Date: May 12, 2011

(54) METHOD OF DISPLAYING NAVIGATION DATA IN 3D

(76) Inventors: Wojciech Tomasz Nowak, Surcharskiego (PL); Arkadiusz Wysocki, Lodz (PL)

(21) Appl. No.: 12/736,811

(22) PCT Filed: Jul. 31, 2008
(86) PCT No.: PCT/EP2008/060089

§ 371 Date: Dec. 28, 2010

(51) Int. Cl. G06T 15/00

(52) U.S. Cl. 345/419

(57) ABSTRACT

A computer arrangement including a processor and memory accessible for the processor is disclosed. In at least one embodiment, the memory includes a computer program including data and instructions arranged to allow the processor to: a) obtain an image to be displayed, b) obtain depth information relating to the image, c) use depth information to identify at least one region in the image, and d) select display mode for at least one identified region.

### FIELD OF THE INVENTION

The present invention relates to a computer arrangement, a method of generating an image for navigational purposes, a computer program product comprising data and instructions that can be loaded by a computer arrangement, allowing said computer arrangement to perform such a method and a data carrier provided with such a computer program product.

### BACKGROUND OF THE INVENTION

Navigation systems have become more popular over the past 20 years. Over the years these systems have evolved from simple geometrical displaying of road centerlines to providing realistic images/photographs of the real-world to help users navigate.

U.S. Pat. No. 5,115,398 by U.S. Philips Corp. describes a method and system of displaying navigation data, comprising generating a forward looking image of a local vehicle environment generated by an image pick-up unit, for example a video camera aboard a vehicle. The captured image is displayed on a display unit. An indication signal formed from the navigation data indicating a direction of travel is superimposed on the displayed image. A combination module is provided to combine the indication signal and the image of the environment to form a combined signal which is displayed on a display unit.

WO2006132522 by TomTom International B.V. also describes to superimpose navigation instructions over a camera image. In order to match the location of the superimposed navigation instructions with the camera image, pattern recognition techniques are used.

An alternative way of superimposing navigation information is described in European patent application EP 1 751 499.

U.S. Pat. No. 6,285,317 describes a navigation system for a mobile vehicle that is arranged to generate direction information which is displayed as overlay on a displayed local scene. The local scene may be provided by a local scene information provider, e.g. being a video camera adapted for use on board the mobile vehicle. The direction information is mapped on the local scene by calibrating the video camera, i.e. determining the viewing angle of the camera, then scaling all points projected onto a projection screen having a desired viewing area by a scaling factor. Also, the height of the camera mounted on the car relative to the ground is measured and the height of the viewpoint in the 3D navigation software is changed accordingly. It will be understood that this procedure is rather cumbersome. Also, this navigation system is not able to deal with objects, such as other vehicles, present in the local scene captured by the camera.

According to the prior, relatively much computer power is needed to provide users with enhanced perspective images for navigation purposes, for instance by using pattern recognition techniques on the images captured by the camera.

### SUMMARY OF THE INVENTION

It is an object of the present invention to provide a method and system that takes away at least one of the above identified problems.

According to an aspect there is provided a computer arrangement comprising a processor and memory accessible for the processor, the memory comprising a computer program comprising data and instructions arranged to allow said processor to:

a) obtain an image to be displayed,

b) obtain depth information relating to the image,

c) use depth information to identify at least one region in the image,

d) select display mode for at least one identified region.

According to an aspect there is provided a method of generating an image for navigational purposes, comprising:

a) obtaining an image to be displayed,

b) obtaining depth information relating to the image,

c) using depth information to identify at least one region in the image,

d) selecting display mode for at least one identified region (examples see below).

According to an aspect there is provided a computer program product comprising data and instructions that can be loaded by a computer arrangement, allowing said computer arrangement to perform such a method.

According to an aspect there is provided a data carrier provided with such a computer program product.

The embodiments provide an easy applicable solution for superimposing navigation information on images, without the need of using sophisticated and computer-time consuming pattern recognition techniques. The embodiments further provide taking into account temporal objects present in the image, such as other vehicles, pedestrians and the like to provide a better interpretable combined image.

### BRIEF DESCRIPTION OF THE DRAWINGS

The invention will be explained in detail with reference to some drawings that are only intended to show embodiments of the invention but not to limit the scope. The scope of the invention is defined in the annexed claims and by its technical equivalents.

The drawings show:

FIG. 1 schematically depicts a computer arrangement,

FIG. 2 schematically depicts a flow diagram according to an embodiment,

FIGS. 3a and 3b schematically depict an image and depth information according to an embodiment,

FIG. 4 schematically depicts a flow diagram according to an embodiment,

FIGS. 5a, 5b, 6a, 6b, 7a, 7b, 8a, 8b and 9 schematically depict combined images,

FIGS. 10a and 10b show images to further explain an embodiment.

### DETAILED DESCRIPTION OF EMBODIMENTS

The embodiments provided below describe a way to provide enhanced images to a user for navigational purposes. The images may show traffic situations or parts of the road network which are shown in an enhanced way, helping users to orient and navigate.

The image may be enhanced for instance by superimposing certain navigational information on specific regions in the image or by displaying some regions of the image with different color settings. More examples will be described below. In general, the enhanced images are created by displaying different regions of the image in different displaying modes. This way, a more intuitive way of presenting navigation instructions or information to a user can be obtained.

In order to display different regions of the image in different displaying modes, these different regions need first to be identified. According to the embodiments, this is achieved by obtaining depth information (three dimensional information) relating to the particular image. The depth information is used to identify different regions and is also mapped to the image. A region may correspond to a traffic sign, a building, an other vehicle, a passer-by. Once different regions are identified and recognized, different regions can be displayed in different displaying modes.

By using depth information there is no need to apply complicated pattern recognition techniques on the images. This way, relatively heavy computations are prevented, while obtaining more user-friendly results.

Computer Arrangement

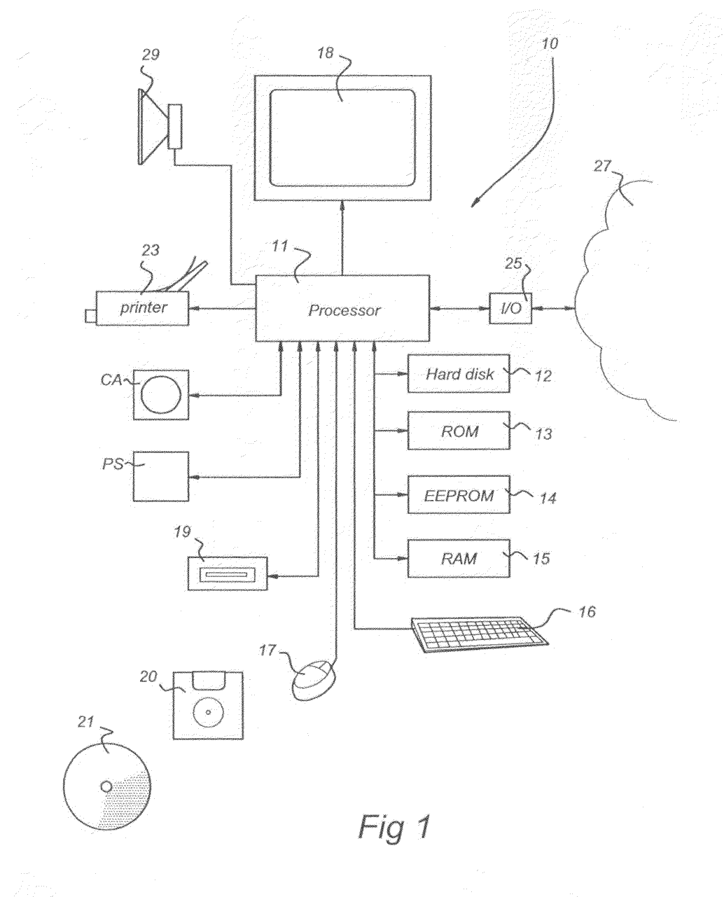

In FIG. 1, an overview is given of a possible computer arrangement 10 that is suitable for performing the embodiments. The computer arrangement 10 comprises a processor 11 for carrying out arithmetic operations.

The processor 11 is connected to a plurality of memory components, including a hard disk 12, Read Only Memory (ROM) 13, Electrically Erasable Programmable Read Only Memory (EEPROM) 14, and Random Access Memory (RAM) 15. Not all of these memory types need necessarily be provided. Moreover, these memory components need not be located physically close to the processor 11 but may be located remote from the processor 11.

The processor 11 is also connected to means for inputting instructions, data etc. by a user, like a keyboard 16, and a mouse 17. Other input means, such as a touch screen, a track ball and/or a voice converter, known to persons skilled in the art may be provided too.

A reading unit 19 connected to the processor 11 is provided. The reading unit 19 is arranged to read data from and possibly write data on a data carrier like a floppy disk 20 or a CDROM 21. Other data carriers may be tapes, DVD, CD-R. DVD-R, memory sticks etc. as is known to persons skilled in the art.

The processor 11 is also connected to a printer 23 for printing output data on paper, as well as to a display 18, for instance, a monitor or LCD (Liquid Crystal Display) screen, or any other type of display known to persons skilled in the art.

The processor 11 may be connected to a loudspeaker 29.

The computer arrangement 10 may further comprise or be arranged to communicate with a camera CA, such as a photo camera, video camera or a 3D-camera, as will be explained in more detail below.

The computer arrangement 10 may further comprise a positioning system PS to determine position information about a current position and the like for use by the processor 11. The positioning system PS may comprise one or more of the following:
a Global Navigation Satellite System (GNSS), such as GPS (global positioning system) unit or the like
a DMI (Distance Measurement Instrument), such as an odometer that measures a distance traveled by the car 1 by sensing the number of rotations of one or more of the wheels 2.
an IMU (Inertial Measurement Unit), such as three gyro units arranged to measure rotational accelerations and three translational accelerators along three orthogonal directions.

The processor 11 may be connected to a communication network 27, for instance, the Public Switched Telephone Network (PSTN), a Local Area Network (LAN), a Wide Area Network (WAN), the Internet etc. by means of I/O means 25. The processor 11 may be arranged to communicate with other communication arrangements through the network 27. These connections may not all be connected in real time as the vehicle collects data while moving down the streets.

The data carrier 20, 21 may comprise a computer program product in the form of data and instructions arranged to provide the processor with the capacity to perform a method in accordance with the embodiments. However, such computer program product may, alternatively, be downloaded via the telecommunication network 27.

The processor 11 may be implemented as stand alone system, or as a plurality of parallel operating processors each arranged to carry out subtasks of a larger computer program, or as one or more main processors with several sub-processors. Parts of the functionality of the invention may even be carried out by remote processors communicating with processor 11 through the network 27.

It is observed that when applied in a car the computer arrangement 10 does not need to have all components shown in FIG. 1. For instance, the computer arrangement 10 does not need to have a loudspeaker and printer then. As for the implementation in the car, the computer arrangement 10 may at least comprise processor 11, some memory 12; 13; 14; 15 to store a suitable program and some kind of interface to receive instructions and data from an operator and to show output data to the operator.

It will be understood that this computer arrangement 10 may be arranged to function as a navigation apparatus.

Camera/Depth Sensor

The term “images” as used in this text refers to images, such as pictures, of traffic situations. These images may be obtained by using a camera CA, such as a photo-camera or video-camera. The camera CA may be part of the navigation apparatus.

However, the camera CA may also be provided remote from the navigation apparatus and may be arranged to communicate with the navigation apparatus. The navigation apparatus may e.g. be arranged to send an instruction to the camera CA to capture an image and may be arranged to receive such an image from the camera CA. At the same time may the camera CA be arranged to capture an image upon receiving instructions from the navigation apparatus and transmit this image to the navigation apparatus. The camera CA and the navigation apparatus may be arranged to set up a communication link, e.g. using Bluetooth, to communicate.

The camera CA may be a three dimensional camera 3CA being arranged to capture an image and depth information. The three dimensional camera 3CA may for instance be a stereo camera (stereo-vision) comprising two lens systems and a processing unit. Such a stereo camera may capture two images at the same time providing roughly the same image taken from a different point of perspective. This difference can be used by the processing unit to compute depth information. Using a three dimensional camera 3CA provides an image and depth information at the same time, where depth information is available for substantially all pixels of the image.

According to a further embodiment, the camera CA comprises a single lens system, but depth information is retrieved by analyzing a sequence of images. The camera CA is arranged to capture at least two images on successive moments in time, where each image provides roughly the same image taken from a different point of perspective. Again the difference in point of perspective can be used to compute depth information. In order to do this, the navigation apparatus uses position information from the positioning system to compute the difference between the points of perspective between the different images. This embodiment again provides an image and depth information at the same time, where depth information is available for substantially all pixels of the image.

According to a further embodiment, depth information is obtained by using a depth sensor, such as a radar, one or more scanners or laser scanners (not shown) that are comprised by the navigation apparatus or are arranged to provide depth information to the navigation information. The laser scanners 3(j) take laser samples, comprising depth information relating to the environment, and may include depth information relating to building blocks, to trees, traffic signs, parked cars, people, etc.

The laser scanners 3(j) may also connected to the microprocessor μP and send these laser samples to the microprocessor μP.

The camera may also generate aerial images, for instance taken from a plane or satellite. These images may provide a vertical downward view or may provide an angled downward view, i.e. providing a perspective or birds eye view.

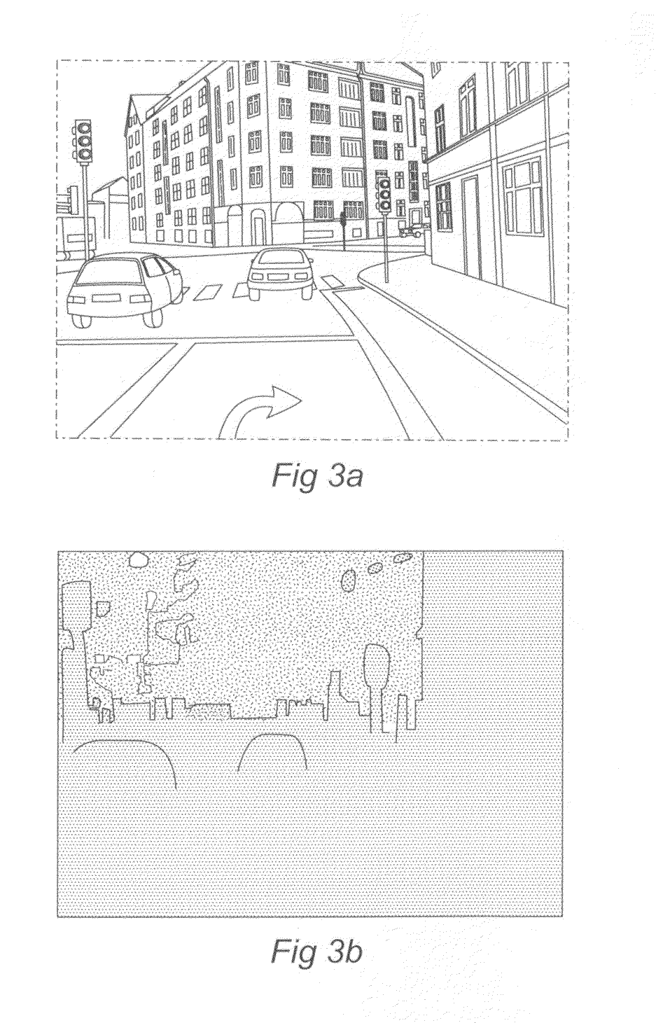

FIG. 3a shows an example of an image, where FIG. 3b shows an example of corresponding depth information. The depth information corresponds to the image shown in FIG. 3a. The image and depth information shown in FIGS. 3a and 3b are obtained using a three dimensional camera, but may also be obtained by analyzing a sequence of images obtained using an ordinary camera or a combination of a camera and a laser scanner or radar suitably integrated. As can be seen in FIGS. 3a and 3b, for substantially each image pixel depth information is available, although it is understood that this is not a requirement.

### Embodiments

According to an embodiment, there is provided a computer arrangement 10 comprising a processor 11 and memory 12; 13; 14; 15 accessible for the processor 11, the memory 12; 13; 14; 15 comprising a computer program comprising data and instructions arranged to allow said processor 11 to:

a) obtain an image to be displayed,

b) obtain depth information relating to the image,

c) use depth information to identify at least one region in the image,

d) select display mode for at least one identified region (examples see below).

The embodiment may further comprise:

e) generate an enhanced image.

After this, the enhanced image may be displayed on display 18.

It will be understood that the actions as described here may be performed in a loop, i.e. may be repeated at predetermined moments, such as at predetermined time intervals, or after a certain movement is detected or distance has been traveled. The loop may ensure that the enhanced image is sufficiently refreshed.

In fact, the images may be part of a video feed. In that case the actions may be performed for each new image of the video feed, or at least sufficiently often to provide a smooth and consistent view for a user.

The computer arrangement 10 may be any kind of computer arrangement, such as a handheld computer arrangement, a navigation apparatus, a mobile telephone, a palmtop, a laptop, a built-in navigation apparatus (built-in to a vehicle), a desk top computer arrangement etc.

The embodiments relate to navigation apparatus providing a user with navigation directions from a start to a destination, but also relate to a navigation apparatus that is just arranged to indicate a current position to a user, or to provide a view of a specific part of the world (e.g. Google maps).

Accordingly, an embodiment is provided relating to a method of generating an image for navigational purposes, comprising:

a) obtaining an image to be displayed,

b) obtaining depth information relating to the image,

c) using depth information to identify at least one region in the image,

d) selecting display mode for at least one identified region (examples see below).

The embodiment may comprise:

e) generating an enhanced image.

After this, the enhanced image may be displayed on display 18.

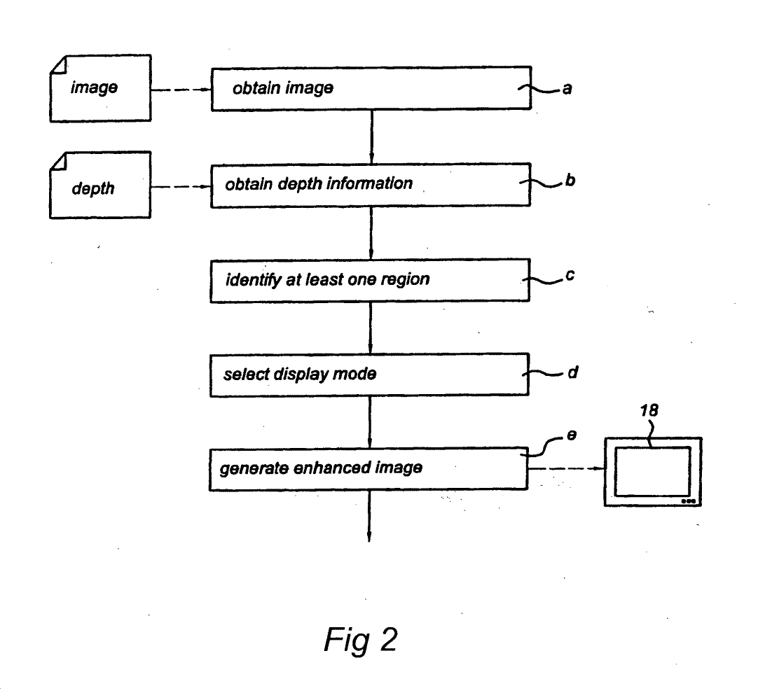

The actions a), b), c), d), e) are schematically shown in FIG. 2, showing a flow diagram as may be performed. The actions a), b), c), d), e) are explained in more detail below. It will be understood that the order of performing the different actions may vary where possible.

The embodiments as described relate to computer arrangements 10 arranged to perform such a method, but also relate to software tools, such as web-based navigation tools (Google maps and the like) that provide a user with the functionality of such a method.

Action a

Action a) comprises obtaining an image to be displayed.

The image may be a picture of part of the world, for instance showing a traffic situation. As explained above, the image may be obtained by using a camera CA, such as a photo-camera or video-camera. The camera CA may be part of the computer arrangement 10 (e.g. a navigation apparatus) or may be a remote camera CA from which the computer arrangement 10 can receive images.

An example of a remote camera CA is for instance a camera mounted on a satellite or air plane providing aerial images. These images may provide a vertical downward view or may provide an angled downward view, i.e. providing a perspective or birds eye view.

An other example of a remote camera CA is a camera built in a vehicle (for instance in the front of the vehicle) or a camera positioned along the side of the road. Such cameras may for instance communicate with the computer arrangement 10 using a suitable communication link, e.g. Bluetooth or an Internet based communication link.

The camera may also be a three dimensional camera 3CA being arranged to capture an image and depth information, where the depth information can be used in action b).

Images may also be obtained from memory 12; 13; 14; 15 comprised by the computer arrangement 10 or from remote memory from which the computer arrangement 10 is arranged to obtain images. Such remote memories may for instance communicate with the computer arrangement 10 using a suitable communication link, such as Bluetooth or an Internet based communication link.

Images stored in (remote) memory may have associated positions and orientations allowing the computer arrangement 10 to select the correct image based on position information from for instance a positioning sensor.

So, according to an embodiment, the computer arrangement comprises a camera CA arranged to obtain an image.

According to a further embodiment, the processor 11 is arranged to obtain an image from one of:
a remote camera,
memory 12; 13; 14; 15,
a remote memory.

Action b)

Action b) comprises obtaining depth information relating to the image.

The computer arrangement 10 may be arranged to compute depth information from at least two images taken from different points of perspective. These at least two images may be obtained in accordance with action a) described above, so may e.g. be obtained from a (remote) camera and a (remote) memory.

The at least two images may be obtained from a three dimensional camera (stereo camera) as describe above. The at least two images may also be obtained from a single lens camera producing a sequence of images from different points of perspective. The computer arrangement 10 may be arranged to analyze the two images to obtain the depth information.

The computer arrangement 10 may also be arranged to obtain depth information from a depth sensor as described above, such as a scanner, laser scanner, radar etc.

Also, the computer arrangement 10 may be arranged to obtain depth information from a digital map database comprising depth information. The digital map database may be a three dimensional map database stored in memory 12; 13; 14; 15 of the computer arrangement 10 or may be stored in a remote memory accessible by the computer arrangement 10. Such a three dimensional digital map database may comprise information about the location and shape of objects, such as buildings, traffic signs, bridges etc. This information may be used as depth information.

So, according to an embodiment the computer arrangement is arranged to obtain depth information by analyzing at least two images obtained by a camera, the camera may be a stereo camera. According to a further embodiment, the computer arrangement comprises a scanner arranged to obtain depth information. Also, the computer arrangement may be arranged to obtain depth information from a digital map database.

Action c)

Action c) comprises using depth information to identify at least one region in the image. The regions to be identified in the image may relate to different objects within the image, such as a region relating to a traffic sign, a building, an other vehicle, a passer-by etc. These objects are to be identified in the image to allow displaying these regions in another display mode as will be explained below.

Different region identification rules may be employed to identify different types of regions. For instance, to identify a traffic sign the identification rules may be searching for a region in the depth information that is flat, substantially perpendicular to the road and has a certain predetermined size. At the same time, for identifying an other vehicle the identification rules may be searching for a region that is not flat but shows a variation in depth information of a few meters and has a certain predetermined size.

It is noted here that different regions may be identified relatively easily by using depth information. However, image recognition techniques applied to the image may be used as well. These image recognition techniques applied to the image may be used
in addition to the identification of regions using depth information, where both techniques are used separately (sequentially or in parallel) and the different results are compared to generate a better end result, or
in cooperation with each other.

This last option may for instance involve using the depth information to identify a region that most likely is a traffic sign, and apply traditional image recognition techniques on the image in a goal-oriented way to determine if the identified region really represents a traffic sign.

It is to be noted that the identification of the at least one region within the image is facilitated by using depth information. By using depth information related to the image, regions can be identified much more easily than when just the image itself is used. In fact, objects/regions can be identified by just using depth information. Once an object/region is identified within the depth information, the corresponding region within the image can be identified by simply matching the depth information to the image.

This matching is relatively easy when both the depth information and the image are taken from a similar source (camera). However, if taken from a different source, this matching can also be performed by applying a calibration action or performing some computations using the mutual orientation and position of the point of view corresponding to the image and the point of view corresponding to the depth information.

As an example, when trying to identify a traffic sign in an image without the use of depth information, pattern recognition techniques are to be used to recognize a region within the image having a certain shape and having certain colors.

When depth information is used, the traffic sign can be identified much more easily by searching in the depth information for a group of pixels having substantially the same depth information (e.g. 8.56 m.), while the surroundings of that group of pixels in the depth information have a substantially higher depth information (e.g. 34.62 m).

Once the traffic sign is identified within the depth information, the corresponding region in the image can easily be identified as well.

Identifying different regions using depth information can be done in many ways, one of which will be explained by way of example below, in which the depth information is used to identify possible traffic signs.

For instance, in a first action all depth information pixels that are too far from the navigation apparatus or road are removed.

In a second action, a search may be conducted in the remaining points to search for a planar object, i.e. a group of depth information pixels that have substantially the same distance (depth value, e.g. 28 meters) and thus lay on a surface.

In a third action, the shape of the identified planar object may be determined. In case the shape corresponds to a predetermined shape (such as circular, rectangular, triangular), the planar object is identified as a traffic sign. If not, the identified planar object is not considered a sign.

Similar approaches can be used for recognizing other objects.

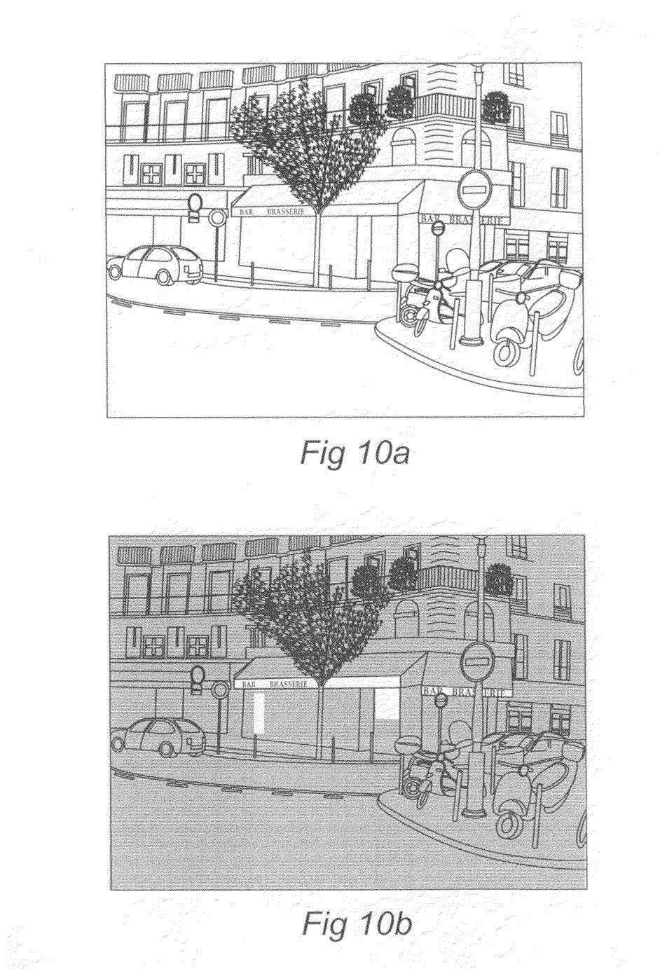

For instance, for recognizing a vehicle, a search may be conducted for a point cloud that has a certain dimension (height/width). For recognizing a shop that is part of a larger building (see FIG. 10a, 10b), a search may be conducted for a planar object that is perpendicular to the road and is at a certain location within the outline of the building. The certain location within the building may previously be stored in memory and may be part of the digital map database.

As described above, image recognition techniques that are applied to the image may be employed as well in addition to or in cooperation with identification of regions using depth information. These image recognition techniques applied to the image may use any known suitable algorithm, such as:
image segmentation,
pattern recognition
active contours
to detect shapes—shape coefficients

Action d)

According to an embodiment, selecting a display mode comprises selecting a display mode from at least one of the following display modes:
color mode
superimpose mode.

These modes will be explained in more detail below.

Color Mode

Different regions in the image may be displayed with a different color mode. For instance, a region that is identified as a traffic sign can be displayed in a bright color mode, while other regions may be displayed in a mat display mode (i.e. having less bright colors). Also, an identified region in the image may be displayed in sepia color mode, while other regions may be displayed in full color mode. Alternatively, an identified region in the image may be displayed in black and white, while other regions may be displayed in full color mode.

The term color mode also refers to different ways of displaying black and white images, where for instance one region is displayed only using black and white, and other regions are displayed also using black, white and grey tones.

Of course, many variations can be conceived.

In fact, applying different color modes for different region can be established by setting different display parameters for different regions, where display parameters may include color parameters, brightness, luminance, RGB-values etc.

Superimpose Mode

According to an embodiment, navigation information is superimposed upon the image. The navigation information is superimposed in such a way that the navigation information has a certain predetermined spatial relationship with objects within the image. A brief explanation of how to do this is provided first.

According to an embodiment there is provided a computer arrangement 10 comprising a processor 11 and memory 12; 13; 14; 15 accessible for the processor 11, the memory comprising a computer program comprising data and instructions arranged to allow said processor 11 to:
I) obtain navigation information,
II) obtain an image corresponding to the navigation information,
III) display the image and at least part of the navigation information, whereby the at least part of the navigation information is superimposed upon the image, wherein the processor 11 is further allowed to
II-1) obtain depth information corresponding to the image and use the depth information to perform action III).

The computer arrangement 10 may be in accordance to the computer arrangement explained above with reference to FIG. 1. The computer arrangement 10 may be a navigation apparatus, such as a hand held or a built-in navigation apparatus. The memory may be part of the navigation apparatus, may be positioned remotely or a combination of this two possibilities.

Accordingly there is provided a method of displaying navigation information, the method comprising:
I) obtaining navigation information,
II) obtaining an image corresponding to the navigation information,
II-1) obtaining depth information corresponding to the image and using the depth information to perform action III), and
III) displaying the image and at least part of the navigation information, whereby the at least part of the navigation information is superimposed upon the image. It will be understood that the method does not necessarily needs to be performed in this particular order.

On top of the image, navigation information may be displayed, such as:
navigation instruction,
selection of a digital map database,
a name,
a sign,
road geometry,
building,
façade of building,
parking lot
point of interest,
indicator.

Navigation information may comprise any kind of navigation instructions, such as an arrow indicating a certain turn or maneuver to be executed. The navigation information may further comprise a selection of a digital map database, such as a selection of the digital map database or a rendered image or object in the database showing the vicinity of a current position as seen in the direction of movement. The digital map database may comprise names, such as street names, city names, etc. The navigation information may also comprise a sign, e.g. a pictogram showing a representation of a traffic sign (stop sign, street sign) or advertisement panel. Furthermore, the navigation information may comprise a road geometry, being a representation of the geometry of the road, possibly comprising lanes, lineation (lane divider lines, lane markings), road inefficiencies, e.g. oil or sand an the road, hole in the road, objects on the road like speed ramps and point of interests, such as shops, museums, restaurants, hotels, etc. It will be understood that the navigation information may comprise any other type of navigation information that when displayed provides a user information that helps him/her to navigate, such as image showing a building or the façade of a building that may be displayed to help a user orient. Also, the navigation information may comprise an indication of a parking lot. The navigation information may also be an indicator, only superimposed to draw a user's attention to a certain object in the image. The indicator may for instance be a circle or square that is superimposed around a traffic sign, to draw the user's attention to that traffic sign.

The computer arrangement may be arranged to perform a navigation function which may compute all kinds of navigation information to help a user orient and navigate. The navigation function may determine a current position using the positioning system and displaying a part of a digital map database corresponding to the current position. The navigation function may further comprise retrieving navigation information associated with the current position to be displayed, such as street names, information about a point of interest.

The navigation function may further comprise computing a route from a start address or current position to a specified destination position and computing navigation instructions to be displayed.

According to an embodiment, the image is an image of a position to which the navigation information relates. So, in case the navigation information is an arrow indicating a right turn to be taken on a specified junction, the image may provide a view of that junction. In fact, the image may provide a view of the junction as seen in a viewing direction of a user approaching that junction.

In case the computer arrangement is arranged to obtain such an image from memory or remote memory, the computer arrangement may use position information to select the correct image. Each image may be stored in association with corresponding position information. In addition to position information, orientation information may be used to select an image corresponding to the viewing direction or traveling direction of the user.

According to an embodiment, action II) comprises obtaining an image from a camera. The method may be performed by a navigation apparatus comprising a built-in camera generating images. The method may also be performed by a navigation apparatus that is arranged to receive images from a remote camera. The remote camera may for instance be a camera mounted on a vehicle.

Therefore, the computer arrangement may comprise or has access to a camera and action II) may comprise obtaining an image from the camera.

According to a further embodiment, action II) comprises obtaining an image from memory. The memory may comprise a database with images. The images may be stored in association with position information and orientation information of the navigation apparatus, to allow selection of the correct image, i.e. the image that corresponds to the navigation information. The memory may be comprised by or accessible by the computer arrangement (e.g. navigation apparatus) performing the method.

The computer arrangement may thus be arranged to obtain an image from memory.

According to an embodiment, the image obtained in action II) comprises depth information corresponding to the image, for use in action II-1). This is explained in more detail below with reference to FIGS. 3a and 3b.

According to an embodiment, action II) comprises obtaining an image from a three dimensional camera. The three dimensional camera may be arranged to capture an image and depth information at once.

As described above, a technique known as stereo-vision may be used for this, using a camera with two lenses to provide depth information. According to an alternative, a camera provided with a depth sensor (e.g. laser scanners) may be used for this. Therefore, the computer arrangement 10 may comprise a three dimensional camera (stereo camera) and action II) may comprise obtaining an image from the three dimensional camera.

According to an embodiment, action II-1) comprises retrieving depth information by analyzing a sequence of images. In order to do this, action II) may comprise obtaining at least two images associated with different positions (using an ordinary camera, i.e. not a three dimensional camera). So, action II) may comprise using a camera or the like to capture more than one image, or retrieve more than one image from memory. Action II-1) may also comprise obtaining images obtained in previous actions II).

The sequence of images may be analyzed and be used to obtain depth information for different regions and/or pixels within the image.

Thus the computer arrangement (e.g. navigation apparatus) may be arranged to perform an action II-1) comprising retrieving depth information by analyzing a sequence of images.

According to an embodiment, action II-1) comprises retrieving depth information from a digital map database, such as a three dimensional map database. A three dimensional map database may be stored in memory in the navigation apparatus or may be stored in a remote memory that is accessible by the navigation apparatus (for instance using an internet or mobile telephone network). The three dimensional map database may comprise information about the road network, street names, one-way streets, points of interest (POI's) and the like, but also includes information about the location and three dimensional shape of objects, such as buildings, entrances/exits of buildings, trees, etc. In combination with a current position and orientation of the camera, the navigation apparatus can compute depth information associated with a specific image. In case the image is obtained from a camera mounted on a vehicle or navigation apparatus, position and orientation information from the camera or vehicle is needed. This may be provided by using a suitable inertial measurement unit (IMU) and/or GPS and/or by using any other suitable device for this.

Thus the computer arrangement (e.g. navigation apparatus) may be arranged to perform an action II-1) comprising retrieving depth information from a digital map database. The digital map database may be a three dimensional map database stored in the memory.

It will be understood that when using the digital map database to retrieve depth information, accurate position and orientation information is required to be able to compute depth information and map this to the image with sufficient accuracy.

According to an embodiment, action II-1) comprises obtaining depth information from a depth sensor. This may be a built-in depth sensor or a remote depth sensor that is arranged to communicate with the computer arrangement. In both case, the depth information has to be mapped to the image.

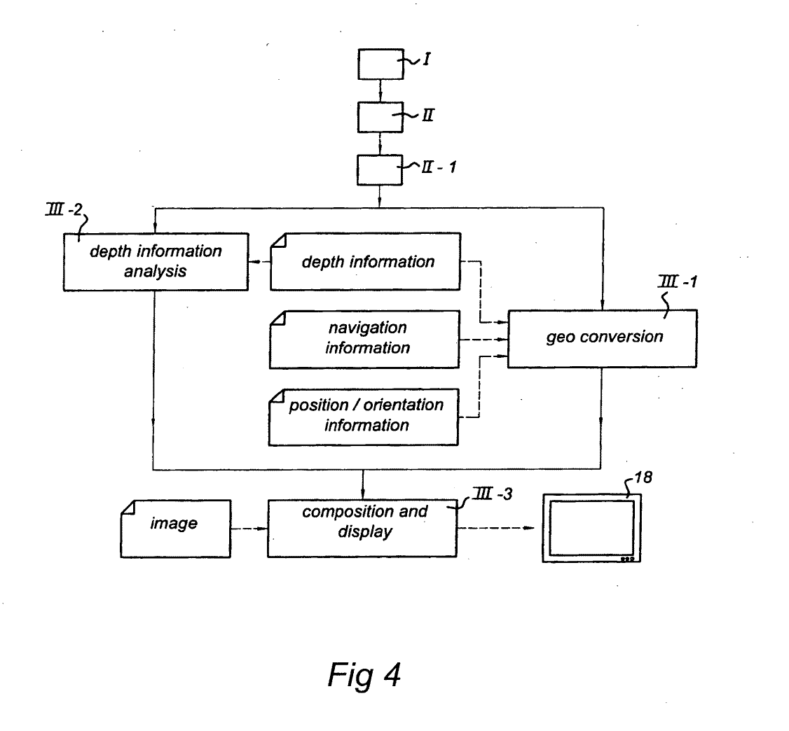

In general, mapping of depth information to the image is done in actions III-1 and/or III-3 explained in more detail below with reference to FIG. 4.

FIG. 3a shows an image as may be obtained in action II), where FIG. 3b shows depth information as may be obtained in action II-1). The depth information corresponds to the image shown in FIG. 3a. The image and depth information shown in FIGS. 3a and 3b are obtained using a three dimensional camera, but may also be obtained by analyzing a sequence of images obtained using an ordinary camera or a combination of a camera and a laser scanner or radar suitably integrated. As can be seen in FIGS. 3a and 3b, for substantially each image pixel depth information is available, although it is understood that this is not a requirement.

In order to achieve the intuitive integration of the image and the navigation information, a geo conversion module may be provided, which may use information about the current position and orientation, position of the image and depth information to convert navigation information using a perspective transformation to match the perspective of the image.

The image and the depth information is taken from a source (such as a three dimensional camera, an external database or a sequence of images) and is used by a depth information analysis module. The depth information analysis module uses the depth information to identify regions in the image. Such a region may for instance relate a building, the surface of the road, a traffic light etc.

The outcome of the depth information analysis module and the geo conversion module are used by a composition module to compose a combined image, being a combination of the image and superimposed navigation information. The composition module merges regions from the depth information analysis module with geo-converted navigation information using different filters and/or different transparencies for different regions. The combined image may be outputted to a display 18 of the navigation apparatus.

FIG. 4 shows a flow diagram according to an embodiment. FIG. 4 provides a more detailed embodiment of action III) as described above.

It will be understood that the modules shown in FIG. 4 may be hardware modules as well as software modules.

FIG. 4 shows actions I), II) and II-1) as described above, now followed by action III) shown in more detail and comprising actions III-1), III-2) and III-3).

According to an embodiment, action III) comprises III-1) performing a geo-conversion action on the navigation information.

This geo-conversion action is performed on the navigation information (e.g. an arrow) to make sure that the navigation information is superimposed upon the image in a correct way. To accomplish this, the geo-conversion action transforms the navigation information to local coordinates associated with the image, e.g. the coordinates that relate the x,y of the image to positions in the real world and are derived from the position, orientation and calibration coefficients of the camera used to obtain the image. By transforming the navigation information into local coordinates the shape of the navigation information is adjusted to match the perspective view of the image. A skilled person will understand how such a transformation to local coordinates can be performed, as it is just a perspective projection of a three dimensional reality to a two dimensional image.

Also, by transforming the navigation information into local coordinates it is ensured that the navigation information is superimposed upon the image in the correct position.

In order to perform this geo-conversion action, the following input may be used:
depth information
navigation information
position and orientation information.

Possibly, camera calibration information is needed as well.

So, according to an embodiment, III) comprises

III-1) performing a geo-conversion action on the navigation information, wherein the geo-conversion action comprises transforming the navigation information to local coordinates. By doing this, the position as well as orientation of the navigation information is adjusted to the perspective of the image. By using the depth information, it is ensured that this transformation to local coordinates is performed correctly, taking into account hills, slopes, orientation of the navigation apparatus/camera etc.

Action III-1) may be performed in an even more accurate way by using input from further position/orientation systems, such as an inertial measurement unit (IMU). Information from such an IMU may be used as an additional source of information to confirm and/or improve the outcome of the geo-conversion action.

Accordingly, the computer arrangement may be arranged to perform an action III) comprising

III-1) performing a geo-conversion action on the navigation information.

Action III-1) may comprise transforming the navigation information from “normal” coordinates to local coordinates.

According to a further embodiment, action III) comprises

III-2) performing a depth information analysis action. In order to perform this depth information analysis action, depth information may be used as input.

According to an embodiment, action III-2) comprises identifying regions in the image and adjusting the way of displaying the navigation information for each identified region in the image.

By using depth information, it is relatively easy to identify different regions. In the depth information three dimensional point clouds can be identified and relatively simple pattern recognition techniques may be used to identify what kind of object such a point cloud represents (such as a vehicle, passer-by, building etc.).

For a certain region the depth information analysis action may decide to display the navigation information in a transparent way or display the navigation information not at all for that region in the image, as to suggest that the navigation information is behind an object displayed by the image in that particular region. The certain region may for instance be traffic light or a vehicle or a building. By displaying the navigation information in a transparent way or not displaying the navigation information at all, a more user-friendly and intuitive view is created for a user.

Therefore, the computer arrangement may be arranged to perform action III-2) comprising

III-2) performing a depth information analysis action.

Action III-2) may comprise identifying regions in the image and adjusting the way of displaying the navigation information for each identified region in the image.

It will be understood that actions III-1) and III-2) may be performed simultaneously and in interaction with each other. In other words, the depth information analysis module and the geo conversion module may work in interaction with each other. An example of such interaction is that both the depth information analysis module and the geo-conversion module may compute pitch and slope information based on the depth information. So, instead of both computing the same pitch and slope values, one of the modules may compute the slope and/or pitch and use this is an additional source of information to confirm if both outcomes are consistent.

Finally, in action III-3) the combine image is composed and outputted, for instance to display 18 of the navigation apparatus. This may be done by the composition module.

Of course, many other types of navigation information can be superimposed upon the image. The display mode for the at least one region may determine how the navigation information is presented. For instance, the navigation information (e.g. an arrow indicating a right turn) may be presented in a transparent or dotted way in a region identified as a traffic sign, building or vehicle, to suggest to a viewer that the arrow passes behind the traffic signs, building or vehicle and thereby creating an intuitive look. More examples of this are provided below.

So, selecting a display mode may involve selecting a superimpose mode where the superimpose mode determines the way the navigation information is displayed in a certain identified region.

Action e)

Action e) finally comprises generating an enhanced image. Of course, after generation of the enhanced image, the enhanced image may be displayed on display 18 to present it to a user.

### Examples

Below a number of examples are shown. It will be understood that combinations of these examples may be employed as well, and many more examples and variations may be conceived.

Examples Superimpose Mode

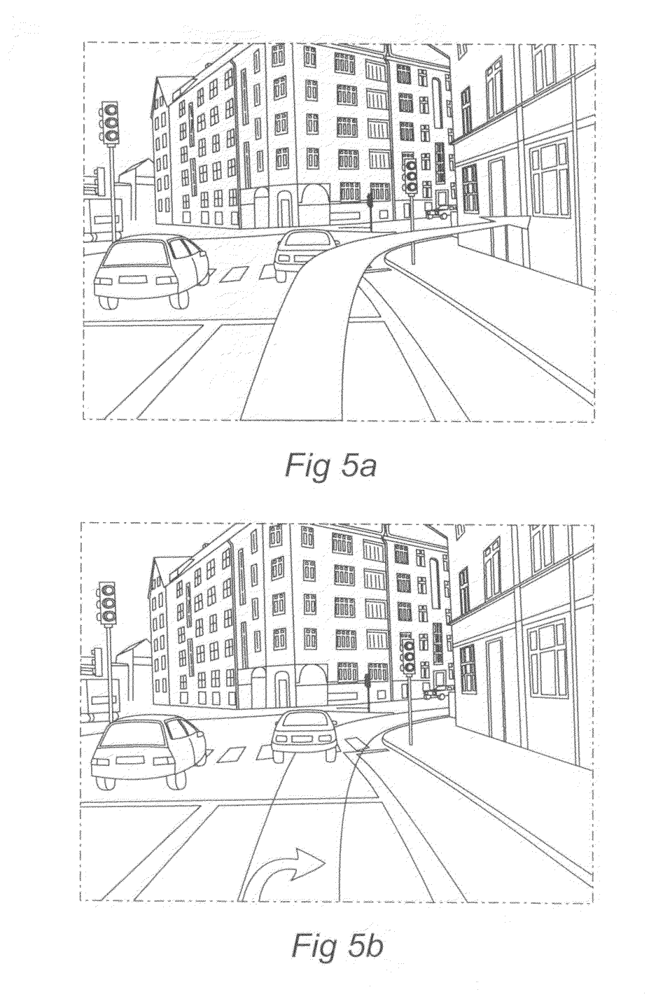

The examples described below with reference to FIGS. 5a-9 all relate to embodiments in which the superimpose mode is set for different regions.

FIG. 5a depicts a resulting view as may be provided by the navigation apparatus not using depth information, i.e. drawing navigation information on a two dimensional image. According to FIG. 5a, the navigation information, i.e. the right turn arrow, seems to suggest traveling through the building on the right.

FIG. 5b depicts a resulting view as may be provided by the navigation apparatus when performing the method as described above. By using depth information it is possible to recognize objects, such as the building on the right, as well as the vehicle and the sign. Accordingly, the navigation information can be displayed in an other display mode for different regions, for instance to be hidden behind the objects or can be drawn with a higher level of transparency.

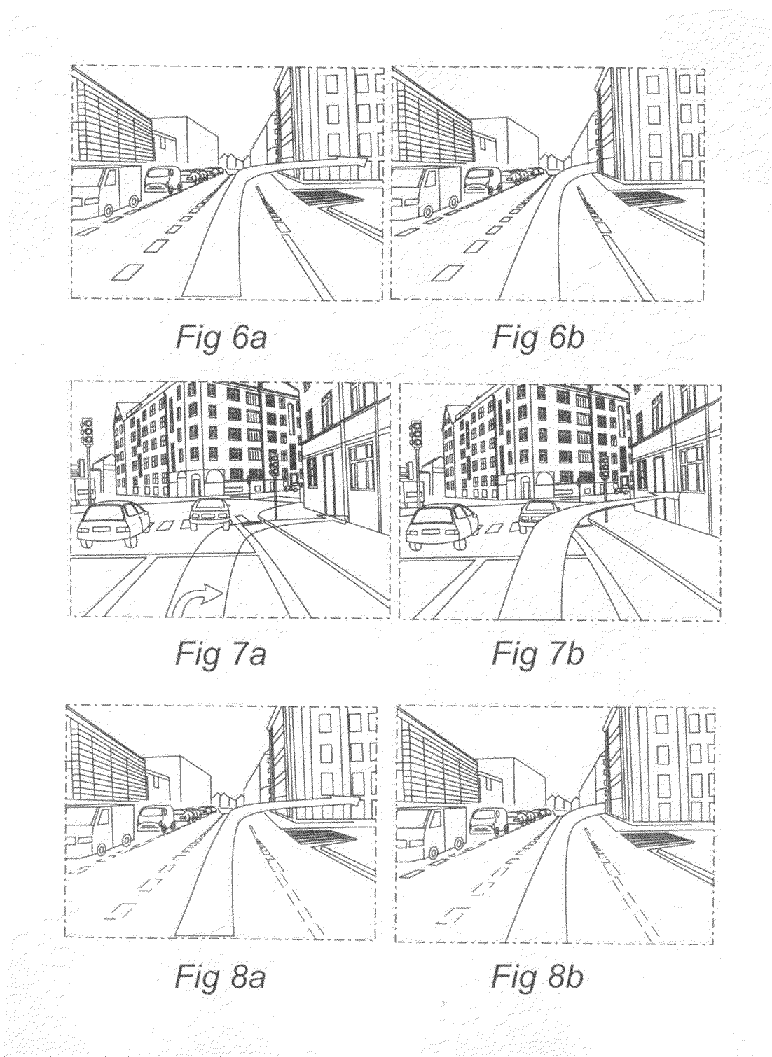

The embodiments decrease the chance on providing possible ambiguous navigation instructions, such as ambiguous maneuver decisions. See for instance FIG. 6a depicting a combined image as may be provided by a navigation apparatus not using depth information according to the embodiment. By using depth information according to the embodiments, a combined image as shown in FIG. 6b may be shown, now clearly indicating that the user should take the second turn to the right and not the first turn. The building on the right is now recognized as a different region, so the display mode of the navigation information (arrow) is changed for that region and is in fact not displayed at all to suggest is disappears behind the building.

Another advantage of the embodiments it the fact the geo-conversion action allows re-shaping of the navigation information (such as an arrow). In case this would not be done, a combined image as shown in FIG. 7a may result, while using the geo-conversion action/module may result in a combined image as shown in FIG. 7b, where the arrow much better follows the actual road surface. The geo-conversion action/module eliminates slope and pitch effects as may be caused by the orientation of the camera capturing the image. It is noted that in the example of FIG. 7b the arrow is not hidden behind the building, although very well possible.

As described above, the navigation information may comprise road geometry. FIG. 8a shows a combined image as may be provided by a navigation apparatus not using depth information according to the embodiment. As can be seen, the road geometry is displayed overlapping objects like vehicles and pedestrians. When using the embodiments, it is possible to identify regions in the image comprising such objects and not display the road geometry within this regions (or display with higher level of transparency). The result of this is shown in FIG. 8b.

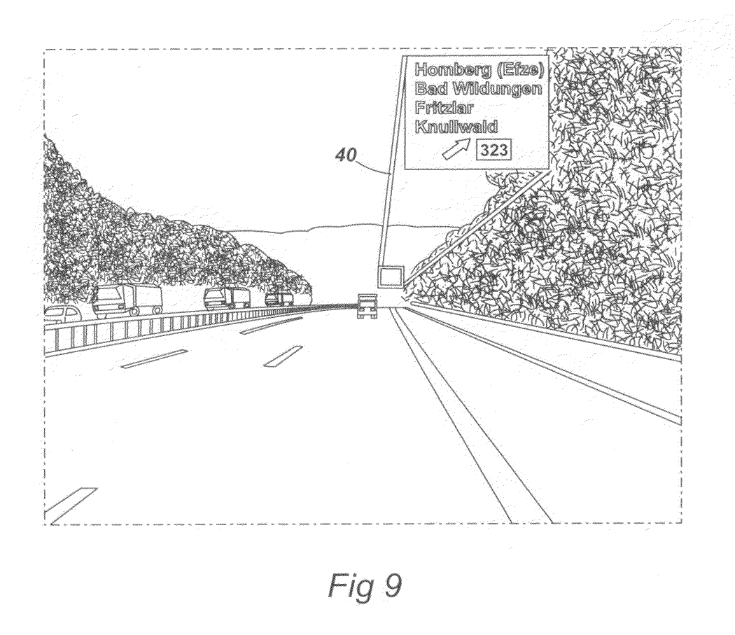

FIG. 9 shows another example. According to this example, the navigation information is a sign corresponding to a sign in the image, wherein in action c) the sign being navigation information is superimposed upon the image in such a way that the sign being navigation information is larger than the sign in the image.

As can be seen in FIG. 9, the sign being navigation information may be superimposed on a position deviating from the sign in the image. To further indicate that the sign being navigation information is associated to the sign in the image (may be not yet very well visible for the user), lines 40 may be superimposed to emphasize which sign is superimposed. The lines 40 may comprise connection lines, connecting the sign being navigation information to the actual sign in the image. The lines 40 may further comprise lines indicating the actual position on the sign in the image.

So, according to this embodiment, action action c) further comprises displaying lines 40 to indicate a relation between the superimposed navigation information and an object within the image.

Of course, according to an alternative, the sign being navigation information may be superimposed to overlap the sign in the image.

It will be understood that superimposing lines or superimposing to overlap the sign in the image can be done in a relatively easy and accurate way by using the depth information.

Examples Colour Mode

FIG. 10a shows an example of an image as may be displayed without employing the embodiments provided here.

FIG. 10b shows an example of the same image as it may be provided after employing one of the embodiments, i.e. after using depth information to determine the location of a bar-brasserie-tabac-shop. This shop is identified as a region and can thus be displayed in a first colour mode (black-white), while the other regions are displayed in a second colour mode (black-white with grey tones). The depth information allows easy identifying other regions such as trees, motor cycles, traffic signs etc. that block direct view of the shop. These other regions can thus be displayed in the second colour mode, providing an intuitive look.

Computer Program and Data Carrier

According to an embodiment there is provided a computer program product comprising data and instructions that can be loaded by a computer arrangement 10, allowing said computer arrangement 10 to perform any of the methods described. The computer arrangement 10 may be a computer arrangement 10 as described above with reference to FIG. 1.

According to a further embodiment there is provided a data carrier provided with such a computer program product.

Further Remarks

It will be understood that the term superimposing is not used in this text to just indicate that one item is displayed upon an other, but is used to indicate that navigation information can be positioned on a predetermined position within the image relative to the content of the image. This way, it is possible to superimpose navigation information such that it is in a spatial relationship with the contents of the image.

So, instead of just merging an image and navigation information, the navigation information can be positioned within the image in an accurate way, such that the navigation information has a logical intuitive relation with the content of the image.

The descriptions above are intended to be illustrative, not limiting. Thus, it will be apparent to one skilled in the art that modifications may be made to the invention as described without departing from the scope of the claims set out below.

1. Computer arrangement comprising a processor and memory accessible for the processor, the memory comprising a computer program comprising data and instructions arranged to allow said processor to at least:
a) obtain an image to be displayed,
b) obtain depth information relating to the image,
c) use depth information to identify at least one region in the image, and
d) select display mode for at least one identified region.

2. Computer arrangement according to claim 1, wherein the processor is further arranged to
e) generating an enhanced image.

3. Computer arrangement according to claim 1, wherein the computer arrangement comprises a camera arranged to obtain an image.

4. Computer arrangement according to claim 1, wherein the processor is arranged to obtain an image from one of:
a remote camera,
memory (12; 13; 14; 15), and
a remote memory.

5. Computer arrangement according to claim 1, wherein the computer arrangement is arranged to obtain depth information by analyzing at least two images obtained by a camera.

6. Computer arrangement according to claim 5, wherein the camera is a stereo camera.

7. Computer arrangement according to claim 1, wherein the computer arrangement comprises a scanner arranged to obtain depth information.

8. Computer arrangement according to claim 1, wherein the computer arrangement is arranged to obtain depth information from a digital map database.

9. Computer arrangement according to claim 1, wherein selecting a display mode comprises selecting a display mode from at least one of the following display modes:
color mode, and
superimpose mode.

10. Method of generating an image for navigational purposes, comprising:
a) obtaining an image to be displayed,
b) obtaining depth information relating to the image,
c) using depth information to identify at least one region in the image, and
d) selecting display mode for at least one identified region.

11. Computer program product comprising data and instructions that can be loaded and executed by a computer arrangement, allowing said computer arrangement to perform the method according to claim 10.

12. Data carrier provided with a computer program product according to claim 11.
